(19) United States
(12) Patent Application Publication
(10) Pub. No.: US 2015/0132572 A1
(43) Pub. Date: May 14, 2015

(54) Polycarbonate Glazing and Method of Preparing the Same

(71) Applicant: Samsung SDI Co., Ltd., Yongin-si (KR)

(72) Inventors: Woo Jin LEE, Uiwang-si (KR); Yukinari HARIMOTO, Uiwang-si (KR); Hyung Rang MOON, Uiwang-si (KR); Chang Soo WOO, Uiwang-si (KR); Seung Woo JANG, Uiwang-si (KR); Hwan Sung CHEON, Uiwang-si (KR); Dong Il HAN, Uiwang-si (KR)

(21) Appl. No.: 14/537,186

(22) Filed: Nov. 10, 2014

(30) Foreign Application Priority Data
Nov. 11, 2013 (KR) 10-2013-0136506

(51) Int. Cl. C08J 7/06; C08J 7/04; B05D 3/02; B05D 7/02; B05D 3/10

(52) U.S. Cl. CPC C08J 7/06; B05D 7/02; B05D 3/107; B05D 3/0254; C08J 7/045; C08J 7/047; C08J 2369/00
USPC 428/336; 428/412; 428/337; 427/344

(57) ABSTRACT

A polycarbonate glazing includes a polycarbonate substrate and a silicon oxide-containing hard coating layer formed on one surface of the substrate, wherein the polycarbonate glazing has a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser, and has a water contact angle from about 40° to about 60°. The polycarbonate glazing may exhibit excellent abrasion resistance and transparency.

### CROSS-REFERENCE TO RELATED APPLICATION

This application claims priority under 35 USC Section 119 to and the benefit of Korean Patent Application 10-2013-0136506, filed Nov. 11, 2013, the entire disclosure of which is incorporated herein by reference.

### FIELD OF THE INVENTION

The present invention relates to a polycarbonate glazing and a method of preparing the same.

### BACKGROUND

Recently, the automobile industry has faced a number of challenges, such as the need for improved fuel efficiency, increasingly stringent environmental regulations, securing passenger safety, reduction in manufacturing costs due to intensifying competition, and the like. To overcome such challenges, various studies have been actively conducted to replace glazing units used in automotive window modules, soft steel plates used in automotive bodies, and the like with lighter metal, plastics, carbon composites, and the like.

In particular, plastics have contributed to the production of lightweight automobiles, improvement in degree of freedom of structural and exterior design, impartment of novel functionality, and cost reduction. In addition, plastics have also contributed to technological development for addressing new environmental regulations, and are preferred as an alternative to metallic components and the like.

For example, plastics, such as polycarbonate (PC), polymethyl methacrylate (PMMA), and the like, are currently used for the preparation of various automotive parts and components, such as B-fillers, headlamps, sunroofs, and the like, due to excellent impact resistance, transparency and moldability thereof. The automotive window module provides a new use for the plastics in order to achieve various advantages in styling/design, weight reduction, stability/safety, and the like.

In particular, the plastics can differentiate a vehicle from competitive vehicles by increasing complexity of overall design and shape. In addition, functional components can be integrated into a molded plastic module, thereby providing automobile manufacturers with capabilities of reducing complexity of a window assembly. Use of a lightweight plastic window module also allows a center of gravity of a vehicle to be lowered and provides improved fuel economy. Further, the plastic window module can stably support passengers upon rollover, thereby improving passenger safety and overall vehicle stability.

However, plastics such as polycarbonate have a problem of poor scratch and abrasion resistance. To improve scratch resistance and abrasion resistance, various attempts have been made to form a silica film as a hard coating layer on a substrate through plasma enhanced chemical vapor deposition (PECVD), CVD, sputtering, a sol-gel process, and the like. However, when PECVD, CVD or sputtering is used, there is a problem in that an apparatus for PECVD, CVD or sputtering is high-priced and control for forming a good-quality film is difficult. In addition, the sol-gel process requires a high burning temperature of 500° C. or more and thus is not easy.

### SUMMARY

In accordance with embodiments of the present invention, a polycarbonate glazing includes: a polycarbonate substrate; and a silicon oxide-containing hard coating layer formed on one surface of the substrate, wherein the polycarbonate glazing has a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser, and has a water contact angle from about 40° to about 60°.

The hard coating layer may be formed from a coating solution including a silicone compound. The silicone compound can include a polysiloxane compound, a polysilsesquioxane compound, or a mixture thereof.

The polycarbonate substrate may have a thickness from about 1 mm to about 10 mm.

The hard coating layer may have a thickness from about 0.1 μm to about 25 μm.

The polycarbonate glazing may further include an interlayer formed between the polycarbonate substrate and the silicone hard coating layer, wherein the interlayer may be a binding layer, a functional layer, or a stacked structure thereof.

The binding layer may include at least one of amide resins, acrylic resins, urethane resins, epoxy resins, siloxane resins, silicone resins, and/or copolymers thereof.

The functional layer may be a UV blocking layer, a buffer layer, an abrasion resistant layer, and/or a barrier layer.

In accordance with other embodiments of the present invention, a method of preparing a polycarbonate glazing includes: forming a coating layer by coating a coating solution including a polysiloxane compound, a polysilsesquioxane compound, or a mixture thereof onto one surface of a substrate; performing acid treatment of the coating layer; and performing heat treatment of the coating layer.

Acid treatment may be performed through surface treatment of the coating layer with a strong acid solution having a pH of about 3 or less for about 15 seconds to about 5 minutes.

The strong acid solution may include at least one of sulfuric acid, nitric acid, hydrogen peroxide, and mixtures thereof.

The strong acid solution may include sulfuric acid and nitric acid in a volume ratio from about 2:1 to about 5:1.

Heat treatment may be performed at about 80° C. to about 150° C. for about 30 minutes to about 2 hours.

Other embodiments of the present invention include a polycarbonate glazing produced by the process of: coating a coating solution comprising a silicone compound onto a surface of a polycarbonate substrate to form a coating layer; acid treating the coating layer; and heat treating the coating layer. The acid treating and heat treating steps convert the silicone compound to a silicon oxide compound to form a silicon oxide-containing hard coating layer on the surface of the substrate. The polycarbonate glazing can have a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser, and has a water contact angle from about 40° to about 60°.

Other exemplary embodiments include a precursor polycarbonate glazing comprising a polycarbonate substrate; and a coating layer comprising a silicone compound on a surface of a polycarbonate substrate. The silicone compound can include a polysiloxane compound, a polysilsesquioxane compound, or a mixture thereof.

### BRIEF DESCRIPTION OF THE DRAWINGS

FIG. 1 illustrates a sectional view of a polycarbonate glazing according to one embodiment of the present invention.

FIG. 2 illustrates a sectional view of a polycarbonate glazing according to another embodiment of the present invention.

### DETAILED DESCRIPTION

Hereinafter, embodiments of the present invention will be described in detail with reference to the accompanying drawings. However, it should be understood that the present invention is not limited to the following embodiments and may be embodied in different ways, and that the embodiments are provided for complete disclosure and thorough understanding of the invention by those skilled in the art. In the drawings, the widths, lengths, thicknesses and the like of components may be exaggerated for convenience. In addition, although only a portion of a component may be illustrated for convenience, the remaining portions of the component can be easily understood by those skilled in the art. It should be noted that the overall drawings are described from the viewpoint of the observer. It will be understood that, when an element such as a layer, film, region or substrate is referred to as being placed on another element, it can be directly placed on the other element, or intervening layer(s) may also be present. Further, it should be understood that various modifications, changes, alterations, and equivalent embodiments can be made by those skilled in the art without departing from the spirit and scope of the invention. Like components will be denoted by like reference numerals throughout the specification.

Polycarbonate Glazing

One embodiment of the present invention relates to a polycarbonate glazing. According to embodiments of the present invention, the polycarbonate glazing may include a polycarbonate-containing substrate and at least one coating layer stacked on the substrate.

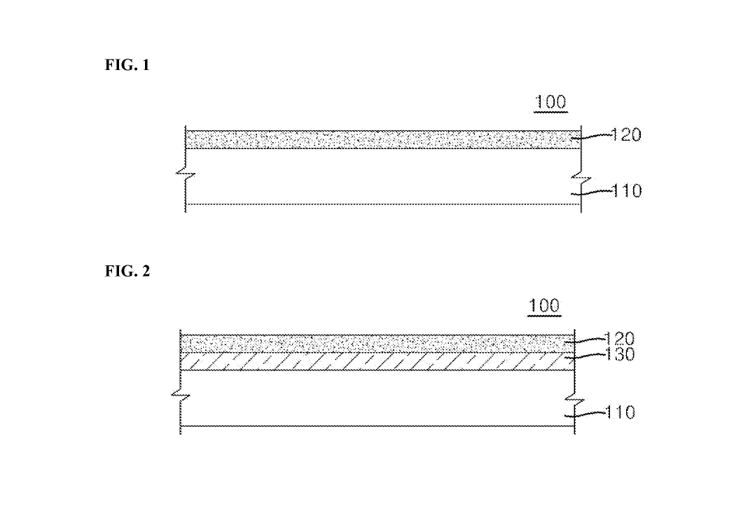

FIG. 1 is a sectional view of a polycarbonate glazing according to one embodiment of the present invention. Referring to FIG. 1, a polycarbonate glazing 100 according to this embodiment may include a polycarbonate substrate 110 and a hard coating layer 120 formed on one surface of the polycarbonate substrate 110.

The polycarbonate substrate 110 includes a polycarbonate resin. The polycarbonate resin may be any polycarbonate resin so long as the polycarbonate resin can provide advantageous effects of the present invention. For example, the polycarbonate resin may include polycarbonate, a polycarbonate copolymer, and/or a polycarbonate-blending resin. The blending resin may be obtained by blending polycarbonate with a polymeric resin, such as polyamides, thermoplastic polyurethanes (TPUs), acrylonitrile-styrene-acrylonitrile, polymethyl methacrylate, polyesters, and/or acrylonitrile-butadiene-styrene, without being limited thereto. In addition, the blending resin may be obtained by blending polycarbonate with a mixture of at least two selected from among these polymeric resins.

In one embodiment, the polycarbonate may be prepared by reacting a dihydric phenol compound with phosgene in the presence of a molecular weight regulator and a catalyst as in a typical preparation method. In addition, in another embodiment, the polycarbonate may also be prepared by transesterification of a dihydric phenol compound and a carbonate precursor, such as diphenyl carbonate.

The dihydric phenol compound may be, for example, a bisphenol compound, such as without limitation 2,2-bis(4-hydroxyphenyl)propane (bisphenol A). Here, bisphenol A may be partially or fully replaced with another dihydric phenol compound.

In one embodiment, the polycarbonate resin may have a tensile strength of about 60 MPa or more and a tensile modulus of about 1.5 GPa or more. Within this range, the polycarbonate resin can exhibit excellent stability required for glazing substrates. The polycarbonate resin may have a Vicat softening point of about 120° C. or more. Within this range, the polycarbonate resin can exhibit excellent workability and excellent properties for the glazing substrates. The polycarbonate resin may have a total light transmittance of about 80% or more. Within this range, the polycarbonate can secure transparency for the glazing substrates and exhibit excellent visibility.

The polycarbonate substrate 110 may have a thickness from about 1 mm to about 10 mm. Within this range, the polycarbonate substrate can exhibit excellent mechanical strength, flexibility, transparency and the like, as a substrate for the polycarbonate glazing.

The hard coating layer 120 is formed on the polycarbonate substrate 110. The hard coating layer 120 may include a silicon oxide (SiOx) compound. In “SiOx”, “x” may have range of about 1 to about 3. For example, the “x” may be about 1, about 1.5, about 2 or about 3.

In one embodiment, the hard coating layer 120 may include a silicon oxide compound formed from a coating solution including a silicone compound. The silicone compound can include, for example, a polysiloxane compound and/or polysilsesquioxane compound.

For example, the hard coating layer 120 may be formed by coating a coating solution including a polysiloxane compound, a polysilsesquioxane compound, or a mixture thereof onto one surface of the polycarbonate substrate 110. In this case, the polysiloxane compound and/or polysilsesquioxane compound included in the coating solution is ceramized through acid treatment and heat treatment, which will be described below, thereby forming a silicon oxide (SiOx)-containing hard coating layer. The hard coating layer may further include residual silicone compound(s) following the acid and heat treatment steps.

The hard coating layer 120 may have a thickness from about 0.1 μm to about 25 μm, for example, from about 0.1 μm to about 15 μm. Within this range, the hard coating layer can secure sufficient abrasion resistance while minimizing cracks thereof.

In addition, the hard coating layer 120 may be formed directly on the polycarbonate substrate 110. The hard coating layer 120 may be formed by a wet process. In this case, sufficient adhesion between the polycarbonate substrate and the coating layer can be secured without formation of a separate primer layer. In one embodiment, the wet process may be non-vacuum wet coating, thereby reducing production time while improving process efficiency.

According to one embodiment, the polycarbonate glazing may secure excellent abrasion resistance by acid treatment of the coating layer, followed by heat treatment.

For example, the polycarbonate glazing may have a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser. The polycarbonate glazing may have a haze difference (ΔHaze), for example, from about 0 to about 4 or from about 0.1 to about 3.5. The haze difference (ΔHaze) is measured in accordance with ASTM D1003 after abrasion testing, as described below in Property Evaluation. In addition, the polycarbonate glazing may have a water contact angle from about 40° to about 60°. Within this range, the polycarbonate glazing can secure excellent abrasion resistance.

ASTM D1003 is a Standard Test Method for Haze and Luminous Transmittance of Transparent Plastics. To evaluate Haze of the polycarbonate glazing, a specimen would be prepared by forming of hard coating layer onto one surface of polycarbonate substrate. For example Light transmittance and Haze can be measured on a 3 mm thick specimen using a Haze meter NDH 2000 (Nippon Denshoku Co., Ltd.) in accordance with ASTM D1003.

An essential component of conducting “Taber wear tests” is the type of abrasive wheel that is used. Taber offers standardized grades of Genuine Taber abrasive wheels, engineered for a variety of specific applications. The wheels are a proprietary formulation developed and designed by Taber Industries so the binder material breaks down during use, exposing and creating a new abrading surface. The minimum usable diameter of Taber abrading wheels is 44.4 mm, which corresponds with the wheel label. Abrading wheels for the Taber Abraser (Abrader) can be classified as:

Calibrase®—A resilient wheel composed of resilient binder and aluminum oxide or silicon carbide abrasive particles. Frequently used to evaluate rigid specimens.

Calibrade®—A non-resilient wheel composed of a vitrified (clay) binder and silicon carbide or aluminum oxide abrasive particles. Frequently used to evaluate flexible specimens.

CS-10F, obtainable from TABER® INDUSTRIES, is a resilient wheel that offers a mild abrading action, designed to operate under loads of 250 or 500 grams. The CS-10F is typically used to test materials such as safety glazing materials and transparent plastics, and should be refaced with the ST-11 refacing stone.

FIG. 2 is a sectional view of a polycarbonate glazing according to another embodiment of the present invention. The polycarbonate glazing shown in FIG. 2 is substantially the same as the polycarbonate glazing according to the above embodiment of except that an interlayer 130 is further formed between the polycarbonate substrate 110 and the hard coating layer 120.

Referring to FIG. 2, an interlayer 130 may be a binding layer, a functional layer, or a stacked structure of the binding layer and the functional layer, and has a structure in which at least one layer is stacked.

The binding layer serves to improve binding strength between the polycarbonate substrate 110 and another layer. In one embodiment, the binding layer may include without limitation at least one of amide resins, acrylic resins, urethane resins, epoxy resins, siloxane resins, silicone resins, and/or copolymers thereof. For example, the binding layer may include without limitation aliphatic polyether thermoplastic polyurethanes, polyester/polyether thermoplastic polyurethanes, anionic aliphatic polyester polyurethanes, anionic aliphatic polyester/polyether polyurethanes, aqueous polyurethanes, polyamides, polyester acrylics, and the like, and mixtures thereof.

The functional layer may include, for example, a UV blocking layer, a buffer layer, an abrasion resistant layer, a barrier layer, or may include a plurality of layers obtained through combination thereof.

In one embodiment, the functional layer may include a material absorbing light at a wavelength from about 200 nm to about 340 nm, which corresponds to a UV region, as a UV absorbent. When the polycarbonate glazing includes a UV absorbent in the functional layer, the polycarbonate substrate can be protected from UV light, thereby improving weather resistance of the polycarbonate glazing.

Examples of the UV absorbent may include without limitation fine metal oxide particles, organic compounds, and the like, and mixtures thereof. The fine metal oxide particles may have an average particle diameter from about 1 nm to about 100 nm, for example, from about 5 nm to about 25 nm. Examples of the fine metal oxide particles may include without limitation zinc oxide, titanium oxide, cerium oxide, iron oxide, and the like. These may be used alone or in combination thereof. Examples of the organic compounds may include without limitation benzophenone, benzotriazole, triazine compounds, and the like, and mixtures thereof.

Further, when the UV absorbent is used, the functional layer may include a HALS agent exhibiting anti-oxidation capabilities. The HALS agent may be, for example, a hindered amine compound.

Furthermore, when the UV absorbent-containing functional layer is used as the interlayer, the functional layer may include a binder resin. Examples of the binder resin may include without limitation acrylate monomers, acrylate oligomers, siloxane monomers, siloxane polymers, silicone monomers, silicone polymers, acrylic resins, urethane resins, epoxy resins, and the like, and mixtures thereof.

In another embodiment, the functional layer may be a buffer layer. The buffer layer may be a silicone buffer layer having a silica network structure formed by condensation of an alkoxysilane hydrolyzed through sol-gel synthesis with colloidal silica sol. The alkoxysilane may be a divalent, trivalent, and/or tetravalent alkoxysilane. Examples of the alkoxysilane may include without limitation vinyltrimethoxysilane, propyltrimethoxysilane, γ-glycidoxypropyltrimethoxysilane, methyltrimethoxysilane, phenyltrimethoxysilane, methacrylopropyltrimethyxosilane, and the like. These may be used alone or in combination thereof.

In a further embodiment, the functional layer may be an acrylic abrasion resistant layer including a photocurable resin and silica nano particles. The photocurable resin may be formed by curing an acrylate functional group-containing UV curable compound. The UV curable compound may be a polyfunctional (meth)acrylate compound, or the like.

Examples of the polyfunctional (meth)acrylate compound may include without limitation ethylene glycol diacrylate, neopentyl glycol di(meth)acrylate, 1,6-hexanediol di(meth)acrylate, trimethylolpropane tri(meth)acrylate, dipentaerythritol hexa(meth)acrylate, polyol poly(meth)acrylate, di(meth)acrylate of bisphenol A-diglycidyl ether, di- or higher functional ester (meth)acrylate, acrylate functional group-containing siloxane compounds, di- or higher functional urethane (meth)acrylate, pentaerythritol tetramethacrylate, glycerin trimethacrylate, and the like, and mixtures thereof. The di- or higher functional ester (meth)acrylate may be obtained by esterification of a polyhydric alcohol, a polyvalent carboxylic acid and anhydrides thereof, and acrylic acid.

The silica nano particles may have an average particle diameter (D50) of about 100 nm or less, for example, from about 10 nm to about 50 nm. The acrylic abrasion resistant layer may include the nano particles in an amount of about 50% by weight (wt %) or less, for example, about 5 wt % to about 40 wt %, based on the total weight of the acrylic abrasion resistant layer. Within this range, the abrasion resistant layer can have improved hardness and thus can exhibit further improved abrasion resistance.

In yet another embodiment, the functional layer may be an inorganic material-containing barrier layer, which can provide further improved scratch resistance. The barrier layer may include at least one inorganic material selected from aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium sulfide, and/or zirconium titanate.

Hereinafter, constitution of the coating solution forming the hard coating layer according to embodiments of the present invention will be described in detail.

Coating Solution for Formation of Hard Coating Layers

According to embodiments of the present invention, the hard coating layer may be formed from a silicone precursor hard coating layer. The silicone precursor hard coating layer may be prepared by coating with a coating solution for formation of hard coating layers.

The coating solution for formation of hard coating layers may include a polysiloxane compound, a polysilsesquioxane compound, or a mixture thereof. The coating solution may include the compound or the mixture along with a solvent.

Hereinafter, components of the coating solution will be described in detail.

(A) Polysiloxane or Polysilsesquioxane

According to embodiments of the present invention, the coating solution is a silicone compound and may include a polysiloxane compound, a polysilsesquioxane compound, or a mixture thereof.

The compound or mixture may be converted into silicon oxide through acid treatment and heat treatment, which will be described below, thereby obtaining a hard coating layer exhibiting excellent abrasion resistance.

The polysiloxane compound may include a repeat unit, which includes a silicon-oxygen-silicon (Si—O—Si) bond unit and is represented by Formula 1. The silicon-oxygen-silicon (Si—O—Si) bond unit can mitigate stress upon curing, thereby reducing shrinkage.

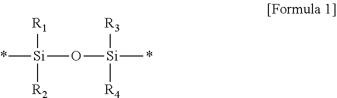

In formula 1, R₁, R₂, R₃ and R₄ are the same or different and are each independently hydrogen, a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or a combination thereof.

As used herein, the term “substituted” means that at least one hydrogen is replaced with at least one of a halogen atom, a hydroxyl group, a nitro group, a cyano group, an amino group, an azido group, an amidino group, a hydrazino group, a carbonyl group, a carbamyl group, a thiol group, an ester group, a carboxyl group or salt thereof, a sulfonic acid group or salt thereof, a phosphate group or salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or a combination thereof.

The polysilsesquioxane compound is represented by R—SiO_{3/2} and may include a material having, for example, a random structure represented by Formula 2, a partial cage structure represented by Formula 3, a cage structure represented by Formula 4, and/or a ladder structure represented by Formula 5:

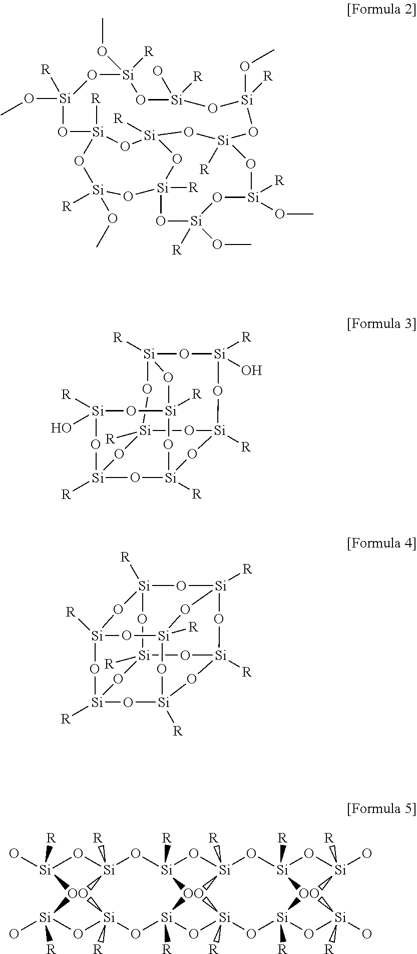

In formulae 2 to 5, each R is the same or different and each is independently hydrogen, a substituted or unsubstituted C1 to C30 alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or a combination thereof.

The polysiloxane compound, the polysilsesquioxane compound, or the mixture thereof may have a weight average molecular weight (Mw) from about 1,000 g/mol to about 25,000 g/mol, for example from about 1,500 g/mol to about 10,000 g/mol. Within this range, since thin film coating can be permitted while reducing components vaporized upon heat treatment, a dense hard coating layer can be formed.

The coating solution can include the polysiloxane compound, the polysilsesquioxane compound, or the mixture thereof in an amount of about 0.1 wt % to about 50 wt % based on the total amount (total weight, 100 wt %) of the coating solution. In some embodiments, the coating solution can include the polysiloxane compound, the polysilsesquioxane compound, or the mixture thereof in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polysilsesquioxane compound, or the mixture thereof can be in a range from about any of the foregoing amounts to about any other of the foregoing amounts.

Within this range, the coating solution can maintain appropriate viscosity, and a flat and uniform hard coating layer can be formed without bubbling and voids.

(B) Solvent

The solvent may be any solvent which does not react with a polysiloxane compound, a polysilsesquioxane compound, or a mixture thereof, and can dissolve a polysiloxane compound, a polysilsesquioxane compound, or a mixture thereof. Examples of the solvent may include without limitation: alcohols such as methanol, ethanol, isopropyl alcohol, n-butanol, isobutanol, t-butanol, diacetone alcohol, propylene glycol methyl ether, propylene glycol ethyl ether, propylene glycol propyl ether, and the like; hydrocarbon solvents such as aliphatic hydrocarbons, alicyclic hydrocarbons, aromatic hydrocarbons, and the like; halogenated hydrocarbon solvents; ethers such as aliphatic ethers, alicyclic ethers, and the like, and mixtures thereof. In exemplary embodiments, examples of the solvent may include hydrocarbons such as pentane, hexane, cyclohexane, toluene, xylene and the like; halogenated hydrocarbons such as methylene chloride, trichloroethane, and the like; ethers such as dibutyl ether, dioxane, tetrahydrofuran, and the like, and mixtures thereof. The solvent may be suitably selected in consideration of solubility of the silicone compound, evaporation rate of the solvent, or the like. In addition, a plurality of the solvents may be mixed.

According to the present invention, the coating solution may additionally include a thermal acid generator (TAG). The thermal acid generator may be used as an additive to prevent contamination due to the uncured polysiloxane compound and/or polysilsesquioxane compound. When the coating solution additionally includes the thermal acid generator, cross-linking temperature of the polysiloxane compound and/or polysilsesquioxane compound can be decreased, thereby improving the cross-linking ratio.

The thermal acid generator may be selected from among any compounds capable of generating hydrogen ions (H+) by heat. In exemplary embodiments, the thermal acid generator can be selected from compounds capable of being sufficiently activated at about 90° C. or more to generate sufficient hydrogen ions and exhibit low volatility. Examples of the thermal acid generator may include without limitation nitrobenzyl tosylate, nitrobenzyl benzenesulfonate, phenol sulfonate, and the like, and combinations thereof.

The coating solution may include the thermal acid generator in an amount of about 25 wt % or less, for example, about 0.01 wt % to about 20 wt %, based on the total amount (total weight, 100 wt %) of the coating solution. In some embodiments, the coating solution can include the thermal acid generator in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the amount of the thermal acid generator can be in a range from about any of the foregoing amounts to about any other of the foregoing amounts.

Within this range, the thermal acid generator can enable development of the silicone compound at a relatively low temperature.

According to embodiments of the present invention, the coating solution may further include a surfactant. Examples of the surfactant may include without limitation: surfactants such as polyoxyethylene alkyl ethers including polyoxyethylene lauryl ether, polyoxyethylene stearyl ether, polyoxyethylene ether, polyoxyethylene oleyl ether, and the like; polyoxyethylene alkyl allyl ethers including polyoxyethylene nonylphenol ether and the like; nonionic surfactants such as polyoxyethylene polyoxypropylene block copolymers, polyoxyethylene sorbitan fatty acid esters including sorbitan monolaurate, sorbitan monopalmitate, sorbitan monostearate, sorbitan monooleate, and the like; fluorine surfactants, such as F-Top EF301, EF303, and/or EF352 (Tohchem Products Co., Ltd.), Megapack F171 and/or F173 (Dainippon Ink & Chemicals Inc.), Fluorad FC430 and/or FC431 (Sumitomo 3M Co., Ltd.), Asahi Guard AG710, Saffron S-382, SC101, SC102, SC103, SC104, SC105, and/or SC106 (Asahi Glass Co., Ltd.), and the like; silicone surfactants such as an organosiloxane polymer KP341 (Shin-Etsu Chemical Co., Ltd.), and the like, without being limited thereto.

The coating solution may include the surfactant in an amount of about 10 wt % or less, for example, about 0.001 wt % to about 5 wt %, based on the total amount (total weight, 100 wt %) of the coating solution. In some embodiments, the coating solution can include the surfactant in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 wt %. Further, according to some embodiments of the present invention, the amount of the surfactant can be in a range from about any of the foregoing amounts to about any other of the foregoing amounts.

Method of Preparing a Polycarbonate Glazing

According to one embodiment of the invention, a method of preparing a polycarbonate glazing may include: forming a coating layer by coating a coating solution including a silicone compounds, such as a polysiloxane compound, a polysilsesquioxane compound, or a mixture thereof, onto one surface of a substrate; performing acid treatment of the coating layer; and performing heat treatment of the coating layer.

First, the coating solution for formation of hard coating layers is coated onto a polycarbonate substrate. The coating solution can include a polysiloxane and/or polysilsesquioxane compound.

The coating solution may be coated by roll coating, spin coating, bar coating, dip coating, flow coating, and/or spray coating, without being limited thereto. In one embodiment, bar coating may be performed through repetition at least once using a Mayer bar No. 24. The coating solution can be applied to the polycarbonate substrate as a single layer or as two or more layers. The coating solution may be coated to a thickness from about 0.1 μm to about 25 μm, followed by drying at about 50° C. to about 100° C. and at about 40% RH to about 90% RH for about 1 minute to about 100 minutes.

Acid treatment can improve conversion of the polysiloxane compound and/or polysilsesquioxane compound included in the coating solution into silica, and thus improve surface hardness and abrasion resistance of the coating layer. In one embodiment, acid treatment may be performed through surface treatment by dipping the substrate having the coating layer formed thereon into a strong acid solution having a pH of about 3 or less for 15 seconds to about 5 minutes. The strong acid solution may include at least one of sulfuric acid, nitric acid, hydrogen peroxide or mixtures thereof, and the strong acid solution may have a pH of 3 or less. For example, the strong acid solution may have a pH of 0.01 to 3, and as another example a pH of 0.1 to 2.5.

In one embodiment, the strong acid solution may include sulfuric acid and nitric acid in a volume ratio from about 2:1 to about 5:1. Within this range, it is possible to prevent process inefficiency due to extended acid treatment time while maintaining suitable reactivity of the strong acid solution.

Heat treatment may be performed at about 80° C. to about 150° C. for about 30 minutes to about 2 hours. Within this range, the components of the coating solution for formation of hard coating layers can be efficiently converted into silicon oxide without deterioration of the substrate.

When heat treatment of the coating layer is completed, the polysiloxane compound and/or polysilsesquioxane compound included in the coating solution is modified into silicon oxide (SiOx) through ceramization, thereby forming a hard coating layer.

Hereinafter, the present invention will be described in more detail with reference to some examples. However, it should be understood that these examples are provided for illustration only and are not to be in any way construed as limiting the present invention. A description of details apparent to those skilled in the art will be omitted for clarity.

### Example 1 and Comparative Examples 1 to 2

### Example 1

A polysilsesquioxane compound (SILFORT-PHC587C, Momentive Co., Ltd.) in an amount of 24 wt % and solvent (mixture of isopropyl alcohol and 1-butanol) are mixed to thereby prepare a polysilsesquioxane compound-containing coating solution. The polysilsesquioxane compound-containing coating solution is coated to a thickness of 7.2 μm onto one surface of a 3 mm thick polycarbonate substrate (LEXAN, GE Co., Ltd.) using a Mayer bar. After coating, the coating solution is subjected to leveling for 20 minutes, followed by drying in a convection oven at 80° C. for 1 hour, and then left alone for 10 minutes, thereby forming a coating layer on the substrate. Separately, a strong acid solution, in which 95% sulfuric acid (Dongwoo Fine-Chem Co., Ltd.), 60% nitric acid (Samchun Chemical Co., Ltd.) and distilled water are mixed in a volume ratio of 66:22:12, is settled at 80° C. for 1 hour, thereby reducing activity of acid. The substrate having the coating layer formed thereon is dipped into the strong acid solution for 2 minutes, and then left alone at room temperature for 3 minutes. Next, the substrate having the coating layer formed thereon is washed with distilled water three times, followed by removal of water from the surface thereof using an air gun to perform acid treatment. The substrate having the coating layer subjected to acid treatment is subjected to heat treatment in a convection oven at 130° C. for 1 hour, thereby preparing a polycarbonate glazing.

The prepared polycarbonate glazing is evaluated as to the following properties. Results are shown in Table 1.

### Comparative Example 1

A polycarbonate glazing is prepared in the same manner as in Example 1 except that acid treatment and heat treatment are not performed. The prepared polycarbonate glazing is evaluated as to the following properties. Results are shown in Table 1.

### Comparative Example 2

A polycarbonate glazing is prepared in the same manner as in Example 1 except that the coating layer is left alone at 28° C. after acid treatment, and heat treatment is not performed. The prepared polycarbonate glazing is evaluated as to the following properties. Results are shown in Table 1.

Property Evaluation

(1) Abrasion resistance: To evaluate abrasion resistance, the polycarbonate glazing is subjected to 500 cycle testing under conditions of a CS-10F abrasion wheel and a load of 500 g using a Taber Abraser. Using a haze meter (NDH 2000N, Nippon Denshoku), haze is measured before and after the abrasion test in accordance with ASTM D1003, thereby calculating a haze difference (ΔHaze).

(2) Water contact angle: Water contact angle is measured 6 times using distilled water and a DAS 100 (Kruess Co., Ltd.) apparatus, followed by calculating an average value.

TABLE 1

| | | | Comparative | Comparative |
|---|---|---|---|---|
| Item | | Example 1 | Example 1 | Example 2 |
| Haze (%) | Before abrasion | 0.9 | 0.5 | 0.8 |
| | After abrasion | 4.1 | 6.1 | 7.2 |
| | ΔHaze | 3.2 | 5.6 | 6.4 |

| | | | |
|---|---|---|---|
| Water contact angle (°) | 46 | 97 | 35 |

As shown in Table 1, it can be seen that the polycarbonate glazing of Example 1, which is subjected to coating with the polysilsesquioxane compound-containing coating solution, followed by acid treatment and heat treatment, has an excellent haze difference (ΔHaze) of 4.5 or less between before and after abrasion, as compared with the polycarbonate glazing of Comparative Example 1, which is not subjected to acid treatment and heat treatment, and the polycarbonate glazing of Comparative Example 2, which is not subjected to heat treatment. In addition, it can be seen that, after 500-cycle testing under conditions of a CS-10F abrasion wheel and a load of 500 g using a Taber Abraser, the polycarbonate glazing of Example 1 has a water contact angle in the range from 40° to 60°.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A polycarbonate glazing comprising:
a polycarbonate substrate; and
a silicon oxide-containing hard coating layer formed on a surface of the substrate,
wherein the polycarbonate glazing has a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser, and has a water contact angle from about 40° to about 60°.

2. The polycarbonate glazing according to claim 1, wherein the hard coating layer is formed from a coating solution including a silicone compound.

3. The polycarbonate glazing according to claim 2, wherein the silicone compound comprises a polysiloxane compound, a polysilsesquioxane compound, or a mixture thereof.

4. The polycarbonate glazing according to claim 1, wherein the polycarbonate substrate has a thickness from about 1 mm to about 10 mm.

5. The polycarbonate glazing according to claim 1, wherein the hard coating layer has a thickness from about 0.1 μm to about 25 μm.

6. The polycarbonate glazing according to claim 1, further comprising:
an interlayer formed between the polycarbonate substrate and the silicone hard coating layer,
wherein the interlayer is a binding layer, a functional layer, or a stacked structure thereof.

7. The polycarbonate glazing according to claim 6, wherein the binding layer comprises at least one of amide resins, acrylic resins, urethane resins, epoxy resins, siloxane resins, silicone resins, and copolymers thereof.

8. The polycarbonate glazing according to claim 6, wherein the functional layer is a UV blocking layer, a buffer layer, an abrasion resistant layer, a barrier layer, or a combination thereof.

9. A polycarbonate glazing produced by the process of:
coating a coating solution comprising a silicone compound onto a surface of a polycarbonate substrate to form a coating layer;
acid treating the coating layer; and
heat treating the coating layer,
wherein the acid treating and heat treating convert the silicone compound to a silicon oxide compound to form a silicon oxide-containing hard coating layer on the surface of the substrate, and
wherein the polycarbonate glazing has a haze difference (ΔHaze) of about 4.5 or less between before and after abrasion, as measured in accordance with ASTM D1003 after 500-cycle testing under conditions of a CS-10F abrasion wheel and a load of 500 g using a Taber Abraser, and has a water contact angle from about 40° to about 60°.

10. The polycarbonate glazing according to claim 9, wherein the silicone compound comprises a polysiloxane compound, a polysilsesquioxane compound, or a mixture thereof.

11. A precursor polycarbonate glazing comprising:
a polycarbonate substrate; and
a coating layer comprising a silicone compound on a surface of a polycarbonate substrate.

12. The precursor polycarbonate glazing according to claim 11, wherein the silicone compound comprises a polysiloxane compound, a polysilsesquioxane compound, or a mixture thereof.

13. A method of preparing a polycarbonate glazing, comprising:
coating a coating solution comprising a silicone compound onto a surface of a polycarbonate substrate to form a coating layer;
acid treating the coating layer; and
heat treating the coating layer.

14. The method according to claim 13, wherein the silicone compound comprises a polysiloxane compound, a polysilsesquioxane compound, or a mixture thereof.

15. The method according to claim 13, wherein acid treatment is performed through surface treatment of the coating layer with a strong acid solution having a pH of about 3 or less for about 15 seconds to about 5 minutes.

16. The method according to claim 15, wherein the strong acid solution comprises at least one of sulfuric acid, nitric acid, hydrogen peroxide, and mixtures thereof.

17. The method according to claim 16, wherein the strong acid solution comprises sulfuric acid and nitric acid in a volume ratio from about 2:1 to about 5:1.

18. The method according to claim 13, wherein heat treatment is performed at about 80° C. to about 150° C. for about 30 minutes to about 2 hours.
